(19) United States
(12) Patent Application Publication
(10) Pub. No.: US 2020/0027036 A1
(43) Pub. Date: Jan. 23, 2020

(54) COMPUTER-IMPLEMENTED METHODS, SYSTEMS, AND COMPUTER-READABLE MEDIA FOR MANAGING RESERVATIONS

(71) Applicant: Mastercard International Incorporated, Purchase, NY (US)

(72) Inventor: Richard B. Unnerstall, O'Fallon, MO (US)

(73) Assignee: Mastercard International Incorporated, Purchase, NY (US)

(21) Appl. No.: 16/042,750

(22) Filed: Jul. 23, 2018

(51) Int. Cl. G06Q 10/02; G06Q 20/40

(52) U.S. Cl. CPC G06Q 10/02; G06Q 20/40

(57) ABSTRACT

A scheduling and management system for managing reservations of rooms and devices includes a computer system and a sensor in communication with the computer system. The computer system implements a reservation scheduling program and other computer programs. The sensor is mounted in or near a room that may be reserved or near or on a device that may be reserved. The sensor monitors occupancy of the room or use of the device and transmits occupancy or use information to the computer system. The computer system evaluates the occupancy or use information and cancels the reservation if the occupancy or use information indicates the room or device is not being used pursuant to the reservation. The computer system also warns users of reservation violations, modifies future reservation rights of users pursuant to customizable rule settings, and triggers payments for rooms that are available to rent.

### FIELD OF THE INVENTION

The present disclosure generally relates to computer-implemented methods, systems, and computer-readable media for scheduling and managing reservations of conference rooms and other rooms and devices.

### BACKGROUND

Corporations and other organizations typically have multiple shared conference rooms that may be reserved and used by employees and other authorized users for meetings. These rooms are typically reserved via email software such as Microsoft® Exchange® or Google® Mail. Such software allows users to reserve rooms months in advance and for recurring days (such as every Tuesday at 9 AM). Unfortunately, users sometimes reserve rooms and then don't use them and/or reserve rooms for longer than they need them. This prevents others from reserving and using the rooms during the reserved time periods even though the rooms are vacant. These same problems apply to shared computers, projectors, and other devices that some organizations provide to their employees for occasional use.

This background discussion is intended to provide information related to the present invention which is not necessarily prior art.

### BRIEF SUMMARY

Embodiments of the present technology solve at least some of the above-described problems by providing a more effective way to schedule and manage reservations of conference rooms and other rooms and devices.

An embodiment of the technology comprises a scheduling and management system for managing reservations of conference rooms and other rooms and devices. The scheduling and management system broadly comprises a computer system and at least one sensor in communication with the computer system. The computer system implements a reservation scheduling program such as those provided in Microsoft® Exchange® or Google® Mail as well as computer programs that implement other aspects of the invention. The computer system may be embodied in any number of application servers, database servers, and the like. The sensor is configured to be mounted in or near a room that may be reserved or near or on a device that may be reserved. The sensor monitors occupancy of the room or use of the device and transmits occupancy or use information to the computer system. The sensor may comprise one or more motion detectors, infrared cameras, door switches, light sensors, or any other devices that can monitor whether a room is occupied or a device is being used.

The scheduling and management system may be used as follows. A user first accesses the computer system and requests to reserve a conference room or other room or device. The request identifies the user, the requested room or device, and the requested day and time. The computer system then determines whether the user is currently permitted to reserve the requested room or device. Details of this step are discussed below. If the user is currently permitted to reserve the requested room or device, the computer system determines whether the room or device is available during the requested time period, and if it is, creates a reservation to reserve the room or device for the requested time period. The scheduling and management system may also send reminders of the reservation to the user.

During the time period of the scheduled reservation, the sensor monitors occupancy of the room or movement or other use of the device and transmits occupancy or use information to the computer system. The computer system evaluates the information and determines if the room or device is being used pursuant to the reservation. If not, the computer system cancels the reservation so that other users may use the room or device. For example, if a meeting room is reserved starting at 2 PM, but the sensor detects no occupancy in the room for 10 minutes after 2 PM, the computer system cancels the reservation. In another example, if a meeting room is reserved starting at 2 PM for 2 hours, and the sensor initially detects occupancy in the room after 2 PM but detects no occupancy after 2:50 PM, the computer system cancels the portion of the reservation after 3 PM. The computer system may also cancel future reservations in a recurring reservation if a user fails to use the reserved room several weeks in a row.

The rules implemented by the computer system for cancelling reservations are customizable so each organization may determine when and how reservations should be cancelled. For example, an organization with ample conference room space may implement a relatively lenient cancellation policy that only cancels or modifies room reservations when reserved rooms are unoccupied for 30 minutes or longer, whereas an organization with limited conference room space may implement a relatively strict cancellation policy that cancels or modifies room reservations when reserved rooms are unoccupied for 5 minutes or longer. An organization may also implement different rules for different rooms or devices. For example, reservations for a heavily-used and highly-desired conference room may be cancelled or modified when the room is unoccupied for 5 minutes or longer, but reservations for an infrequently-used projector may be cancelled or modified only after the projector remains unused for 30 minutes or longer. Similarly, an organization may implement different rules for different users. For example, reservations made by executives may be cancelled or modified when reserved rooms or devices are unused for 30 minutes or longer, but reservations made by part-time independent contractors or others who are frequently not in the office may be cancelled or modified when reserved rooms or devices are unused for 10 minutes or longer.

The computer system also warns users of reservation violations. For example, anytime a reservation is cancelled or cut-short, the computer system may send the user a warning via email or text to inform the user the meeting room or device was not used pursuant to the reservation and therefore the reservation was cancelled. Such warnings may also be sent to managers, scheduling administrators, or others and may include notices of changes to the user's future reservation rights as discussed below.

The computer system may also modify future reservation rights of users pursuant to customizable rule settings. For example, the computer system may suspend or otherwise limit a user's ability to make additional reservations when the user fails to use a room or device pursuant to a previous reservation. As with the above-described rules for cancelling current reservations, the rules for modifying future reservation rights are customizable so each organization may determine when and how future reservation rights should be restricted. For example, an organization with ample conference room space may implement a relatively lenient rights policy that only prevents or restricts future reservations when users have multiple reservation violations, whereas an organization with limited conference room space may implement a relatively strict rights policy that that prevents future reservations when users have a single reservation violation. An organization may also implement different reservation rights policies for different rooms or devices. For example, reservations for heavily-used and highly-desired conference rooms may be available only to users with no reservation violations in the last year, whereas reservations for infrequently-used projectors or other devices may be available to any users with no reservation violations in the last 5 days. Similarly, an organization may implement different future reservation rights policies for different users. For example, future reservation rights of executives may be cancelled or suspended for short times when they have multiple reservation violations, whereas future reservation rights of part-time independent contractors may be cancelled or suspended for longer times when they have fewer reservation violations.

In other embodiments, the scheduling and management system may also trigger payments for rooms or devices that are available to rent, such as meeting rooms, exercise equipment, or other rooms and devices provided by hotels and other similar organizations. Authorized users who wish to have access to a room or device for rent first enter or otherwise provide payment information to the computer system. Alternatively, such payment information may be provided or automatically detected at the time of use of the room or device. The sensor monitors occupancy of the room or use of the device and transmits occupancy or use information to the computer system. The computer system evaluates the occupancy or use information transmitted by the sensor and initiates a payment transaction if the occupancy or use information indicates a room or device is being used.

Another embodiment of the technology comprises a computer-implemented method for managing reservations of conference rooms and other rooms and devices. The method may include the steps of receiving in a computer system a reservation request from a user to reserve a room or device for a time period; creating a reservation with the computer system to reserve the room or device for the user for the time period; monitoring occupancy of the room or use of the device during the time period to determine if the user is using the room or device pursuant to the reservation; cancelling the reservation if the monitoring step determines the user is not using the room or device pursuant to the reservation; and modifying future reservation rights of the user pursuant to customizable rule settings if the user has reservation violations. The method may include additional, less, or alternate actions, including those discussed elsewhere herein.

Advantages of these and other embodiments will become more apparent to those skilled in the art from the following description of the exemplary embodiments which have been shown and described by way of illustration. The present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWING FIGURES

The Figures described below depict various aspects of methods, systems, and computer-readable media disclosed herein. Each Figure may depict an embodiment of a particular aspect of the disclosed inventions. Further, wherever possible, the following description refers to the reference numerals included in the following Figures, in which features depicted in multiple Figures are designated with consistent reference numerals. The disclosed embodiments are not limited to the precise arrangements and instrumentalities shown in the Figures.

FIG. 1 is a schematic diagram illustrating various components of an exemplary scheduling and management system which may be used for scheduling and managing reservations of conference rooms and other rooms and devices according to embodiments of the present invention;

FIG. 2 illustrates various components of an exemplary computer system shown in block schematic form that may be part of the scheduling and management system of FIG. 1 and that may host at least portions of the software of the present invention;

FIG. 3 illustrates various components of an exemplary electronic device shown in block schematic form that may be used with the scheduling and management system of FIG. 1; and

FIG. 4 illustrates at least a portion of the steps of an exemplary computer-implemented method according to an embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer-implemented methods, computer systems, and computer software on computer-readable media for scheduling and managing reservations of conference rooms and other rooms and devices. As used herein, the terms “room” or “rooms” encompass conference rooms, meeting rooms, board rooms, hotel rooms, park shelters, club houses, sport courts, workout rooms, or any other room, space, or area which typically must be reserved before it can be used. As used herein, the terms “device” and “devices” encompass computers, projectors, office equipment, vehicles, and other things which are sometimes provided for temporary use by corporations or other organizations.

An embodiment of the technology comprises a scheduling and management system for managing reservations of conference rooms and other rooms and devices. The scheduling and management system broadly comprises a computer system and at least one sensor in communication with the computer system. The computer system may also be coupled with or be able to communicate with a payment interchange such as the Mastercard® interchange network or the Mastercard® Send API.

The computer system implements a reservation scheduling program such as those provided in Microsoft® Exchange® or Google® Mail as well as one or more computer programs that implement other aspects of the invention. The sensor is configured to be mounted in or near a room that may be reserved or near or on a device that may be reserved. The sensor monitors occupancy of the room or use of the device and transmits occupancy or use information to the computer system. The sensor may comprise one or more motion detectors, infrared cameras, door switches, light sensors, or any other devices that can monitor whether a room is occupied.

The computer system evaluates the occupancy or use information and cancels the reservation if the occupancy or use information indicates the room or device is not being used pursuant to the reservation. The computer system also warns users of reservation violations and modifies future reservation rights of users pursuant to customizable rule settings. The scheduling and management system may also trigger payments for rooms that are available to rent, such as hotel meeting rooms.

Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

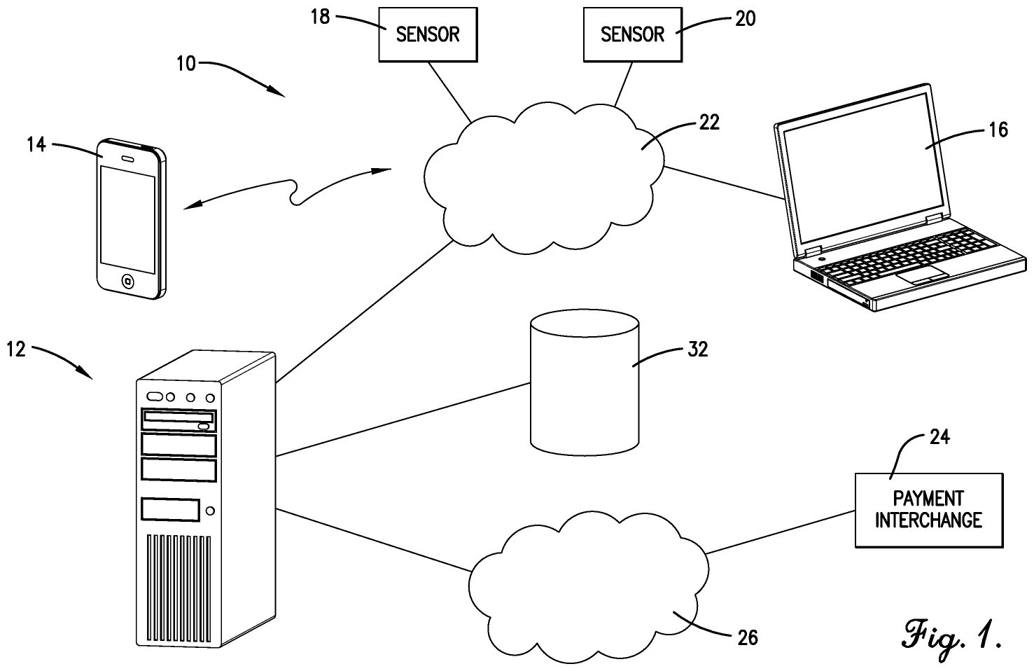

FIG. 1 depicts an exemplary scheduling and management system 10 that may be used to implement embodiments of the invention, including methods and software for managing reservations of conference rooms and other rooms and devices. The scheduling and management system 10 broadly includes a computer system 12 that at least partially hosts reservation software and other computer programs, electronic devices 14, 16 that may be operated by users to access the computer system 12, and exchange information with the computer system, and sensors 18, 20 that sense occupancy of rooms and/or use of devices as described below. The computer system 12, electronic devices 14, 16, and sensors 18, 20 may exchange information and otherwise communicate via a communications link 22. The computer system 12 may also communicate with other systems including a payment interchange 24 via a communications link 26. Although the system 10 illustrated in FIG. 1 only shows two electronic devices 14,16 operated by users and two sensors 18, 20, the system 10 may include any number of such devices. Similarly, the system 10 may include any number of other servers, communication links, and hardware and/or software components.

The computer system 12 receives information from the electronic devices 14, 16 and the sensors 18, 20, and issues instructions, and provides a user interface for receiving and transmitting information according to embodiments of the present invention, as discussed in more detail below. The computer system 12 also at least partially hosts reservation software and other computer programs as described in more detail below.

The computer system 12 may be embodied by any number of application servers, database servers, file servers, gaming servers, mail servers, print servers, web servers, or the like, or combinations thereof. The computer system 12 may be configured to include or execute software such as file storage applications, database applications, email or messaging applications, web server applications, or the like, in addition to and/or in conjunction with the reservation software described herein.

The computer system 12 may apply business methods or algorithms, may utilize lookup tables or databases, receive user input via one or more peripheral devices or associated systems, or perform other tasks. The computer system 12 may perform such tasks in order to act as a secure gateway to receive and store reservation information and to perform other functions described herein.

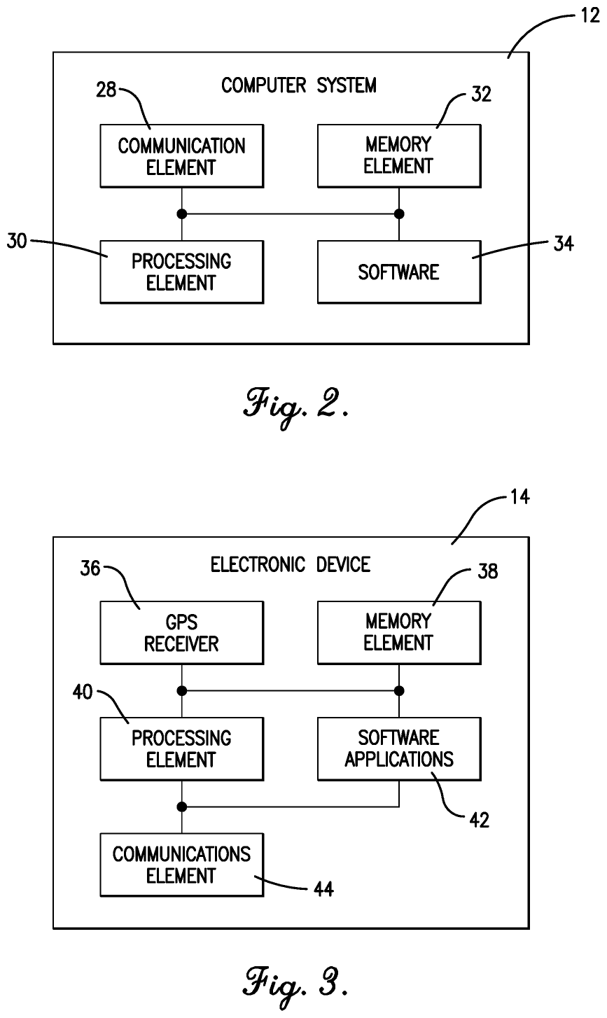

One exemplary embodiment of the computer system 12 is shown in FIG. 2 and includes a communication element 28, a processing element 30, and a memory element 32 and is shown hosting reservation software 34 and other computer programs. The computer system 12 may be located anywhere, but at least a portion of the functionality of the computer system 12 is at least temporarily reserved for use in managing reservations for a company or other organization.

The communication element 28 of the computer system 12 allows data exchange and other communications with external systems or devices such as the electronic devices 14, 16, the sensors 18, 20, and the payment interchange 24. The communication element 28 may include signal or data transmitting and receiving circuits, such as antennas, amplifiers, filters, mixers, oscillators, digital signal processors (DSPs), and the like. The communication element 28 may establish communication wirelessly by utilizing RF signals and/or data that comply with communication standards such as cellular 2G, 3G, 4G, or 5G, IEEE 802.11 standard such as WiFi, IEEE 802.16 standard such as WiMAX, Bluetooth™, or combinations thereof. Alternatively, or in addition, the communication element 28 may establish communication through connectors or couplers that receive metal conductor wires or cables which are compatible with networking technologies such as ethernet. In certain embodiments, the communication element 28 may also couple with optical fiber cables. The communication element 28 is also in communication with or electronically coupled to the memory element 32 and/or the processing element 30.

The processing element 30 of the computer system 12 may include processors, microprocessors, microcontrollers, DSPs, field-programmable gate arrays (FPGAs), analog and/or digital application-specific integrated circuits (ASICs), or the like, or combinations thereof. The processing element 30 may generally execute, process, or run the pay application and/or other instructions, code, code segments, software, firmware, programs, applications, apps, processes, services, daemons, or the like. The processing element 30 may also include hardware components, such as finite-state machines, sequential and combinational logic, and other electronic circuits that may perform the functions necessary for the operation of embodiments of the current inventive concept. The processing element 30 may be in communication with the other electronic components through serial or parallel links that include address busses, data busses, control lines, and the like.

The memory element 32 of the computer system 12 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory element 32 may include, or may constitute, a “computer-readable medium.” The memory element 32 may store the reservation software 34 and/or other computer programs instructions, code, code segments, software, firmware, programs, applications, apps, services, daemons, or the like that are executed by the processing element 30. The memory element 32 may also store reservations, settings, data, documents, databases, and the like.

The memory element 32 may also store reservation information and related information, in one or more databases as depicted in FIG. 1. Any such databases may include a single database having separated sections or partitions or may include multiple databases, each being separate from each other.

The electronic devices 14, 16 are operated by users to reserve meeting rooms or other rooms or devices and may each be embodied by a smart watch, smart phone, personal digital assistant (PDA), tablet computer, palmtop or laptop computer, notebook computer, netbook computer, smart glasses, wearable and non-wearable electronics (e.g., any IoT devices), or any other electronic device. Selected components of an exemplary electronic device 14 are shown in FIG. 3 and may include a GPS receiver element 36, a memory element 38, a processing element 40, software applications 42, and a communications element 44. The components of the electronic devices 14, 16—including the communication element 44, processing element 40, and memory element 38—operate and are constructed according to similar principles and with similar components to those set forth above with respect to analogous components of the computer system 12. The GPS receiver 36 may operate according to known principles for GPS receivers and/or chips common to smartphones, for example. The memory element 38 may store parts of the reservation software or software applications 42 configured to interact with the reservation software 34, and the processing element 40 may execute the software applications.

The sensors 18, 20 monitor occupancy of a room or movement or other use of a device and send corresponding signals to the computer system 12. The sensors may be motion detectors, infrared cameras, door switches, light sensors, or any other devices that can monitor whether a room is occupied or a device is in use. In other embodiments of the invention, the sensors may include some of the processing capabilities of the computer system. For example, rather than generating and sending occupancy and/or use information to the computer system so that the computer system can determine if a room or device is being used pursuant to a reservation, the sensors themselves may have a processor or other computing device programmed to determine if a room or device is being used as scheduled, and if not, cancel the registration and modify future reservation rights as discussed below.

The communication links 22 and 26 allow communication between the computer system 12, the electronic devices 14, 16, and the sensors 18, 20 and between the computer system 12 and the payment interchange 24. The communication links 22, 26 may include local area networks, metro area networks, wide area networks, cloud networks, the Internet, cellular networks, plain old telephone service (POTS) networks, and the like, or combinations thereof. The communication links 22, 26 may be wired, wireless, or combinations thereof and may include components such as modems, gateways, switches, routers, hubs, access points, repeaters, towers, and the like. For example, the electronic devices 14, 16 may generally connect to the communication link 22 wirelessly, such as radio frequency (RF) communication using wireless standards such as cellular 2G, 3G, 4G, or 5G, Institute of Electrical and Electronics Engineers (IEEE) 802.11 standards such as WiFi, IEEE 802.16 standards such as WiMAX, Bluetooth®, or combinations thereof.

In some embodiments, the communications links 22, 26 are separate, but in other embodiments they are parts of the same communications network. For example, in one embodiment, the communications link 22 is a wireless, private, local area network and the communications link 26 is the Internet, but in other embodiments both communications links are part of the same local area network.

The devices of the system 10 preferably communicate via secure and/or encrypted communication means. For example, all or some of the devices may utilize Mutual Secure Sockets Layer (MSSL) technology for authenticating and exchanging transmissions. The system 10 may also use enterprise-standard encryption to secure communications.

The reservation software 34 and all its features and functionalities are embodied in the form of computer-executable instructions embodied in a computer-readable medium such as the memory element 32 and/or the memory element 38. The reservation software 34 may be hosted by the computer system 12 or a computer system in communication with the computer system 12 and may include mobile applications that may be downloaded and installed on the electronic devices 14, 16. The reservation software and its features and processes are not limited to the specific embodiments described herein. In addition, components of the system 10 can be practiced independent and separate from the reservation software 34 and other components and processes described herein. Each component and process can also be used in combination with other systems and processes.

The payment interchange 24 may comprise or interact with a transaction card system, such as a credit card payment system using the MasterCard® interchange network and/or the MasterCard® Send API. Embodiments of the present invention may use the payment interchange 24 to trigger payments for rooms and devices as also described above and below. The MasterCard® interchange network and MasterCard® Send API are sets of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.). As used herein, financial transaction data includes a unique account number associated with a merchant, consumer, or other account holder using a payment card issued by an issuer, purchase data representing a purchase made by the cardholder, including a type of merchant, amount of purchase, date of purchase, and other data, which may be transmitted between any parties of multi-party transactions.

Aspects of a conventional transaction card system will now be summarized. In a typical transaction card system, a financial institution called the “issuer” issues a transaction card, such as a credit card, to a consumer or cardholder, who uses the transaction card to tender payment for a purchase from a merchant. To accept payment with the transaction card, merchant must normally establish an account with a financial institution that is part of the financial payment system. This financial institution is usually called the “merchant bank,” the “acquiring bank,” or the “acquirer.” When cardholder tenders payment for a purchase with a transaction card, merchant requests authorization from a merchant bank for the amount of the purchase. The request may be performed over the telephone but is usually performed using a point-of-sale terminal, which reads cardholder's account information from a magnetic stripe, a chip, or embossed characters on the transaction card and communicates electronically with the transaction processing computers of merchant bank. Alternatively, merchant bank may authorize a third party to perform transaction processing on its behalf. In this case, the point-of-sale terminal will be configured to communicate with the third party. Such a third party is usually called a “merchant processor,” an “acquiring processor,” or a “third party processor.”

Using the payment interchange 24, computers of merchant bank or merchant processor will communicate with computers of an issuer bank to determine whether cardholder's account is in good standing and whether the purchase is covered by cardholder's available credit line. Based on these determinations, the request for authorization will be declined or accepted. If the request is accepted, an authorization code is issued to merchant.

When a request for authorization is accepted, the available credit line of cardholder's account is decreased. Normally, a charge for a payment card transaction is not posted immediately to cardholder's account because bankcard associations, such as MasterCard International Incorporated®, have promulgated rules that do not allow merchant to charge, or “capture,” a transaction until goods are shipped or services are delivered. However, with respect to at least some debit card transactions, a charge may be posted at the time of the transaction. When merchant ships or delivers the goods or services, merchant captures the transaction by, for example, appropriate data entry procedures on the point-of-sale terminal. This may include bundling of approved transactions daily for standard retail purchases. If cardholder cancels a transaction before it is captured, a “void” is generated. If cardholder returns goods after the transaction has been captured, a “credit” is generated. Interchange network and/or issuer bank stores the transaction card information, such as, and without limitation, a type of merchant, a merchant identifier, a location where the transaction was completed, an amount of purchase, and a date and time of the transaction, in a database.

After a purchase has been made, a clearing process occurs to transfer additional transaction data related to the purchase among the parties to the transaction, such as merchant bank, interchange network, and issuer bank. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, cardholder's account is decreased. Normally, a charge is posted immediately to cardholder's account. The payment card association then transmits the approval to the acquiring processor for distribution of goods/services or information, or cash in the case of an automated teller machine (ATM).

After a transaction is authorized and cleared, the transaction is settled among merchant, merchant bank, and issuer bank. Settlement refers to the transfer of financial data or funds among merchant's account, merchant bank, and issuer bank related to the transaction. Usually, transactions are captured and accumulated into a “batch,” which is settled as a group. More specifically, a transaction is typically settled between issuer bank and interchange network, and then between interchange network and merchant bank, and then between merchant bank and merchant.

The scheduling and management system 10 may be used as follows. A user first accesses the computer system 12 with one of the electronic devices 14, 16 to request to reserve a conference room or other room or device. The request identifies the user, the requested room or device, and the day and time for the reservation. The computer system 12 then determines whether the user is currently permitted to reserve the requested room or device. Details of this step are discussed below. If the user is currently permitted to reserve the requested room or device, the computer system 12 determines whether the room or device is available during the requested time period, and if it is, creates a reservation to reserve the room or device for the requested time period. The computer system 12 may also send confirmations and reminders of the reservation to the user or others.

During the time period of the scheduled reservation, the sensors 18, 20 monitor occupancy of the reserved room or use of the reserved device and transmit occupancy or use information to the computer system 12. The computer system 12 evaluates the information and cancels the reservation if the information indicates the room or device is not being used pursuant to the reservation. For example, if a meeting room is reserved starting at 2 PM, but the sensor 18 detects no occupancy in the room for 10 minutes after 2 PM, the computer system 12 cancels the reservation so others may use the room. In another example, if a meeting room is reserved starting at 2 PM for 2 hours, and the sensor 18 initially detects occupancy in the room after 2 PM but detects no occupancy after 2:50 PM, the computer system 12 cancels the portion of the reservation after 3 PM so others may use the room. The computer system may also cancel future reservations in a recurring reservation (such as every Tues at 9 AM) if a user fails to use the reserved room several weeks in a row.

The rules implemented by the computer system 12 for cancelling reservations are customizable so each organization may determine when and how reservations should be cancelled. For example, an organization with ample conference room space may implement a relatively lenient cancellation policy that only cancels or modifies room reservations when reserved rooms are unoccupied for 30 minutes or longer, whereas an organization with limited conference room space may implement a relatively strict cancellation policy that cancels or modifies room reservations when reserved rooms are unoccupied for 5 minutes or longer. An organization may also implement different rules for different rooms or devices. For example, reservations for a heavily-used and highly-desired conference room may be cancelled or modified when the room is unoccupied for 5 minutes or longer, but reservations for an infrequently-used projector may be cancelled or modified only after the projector remains unused for 30 minutes or longer. Similarly, an organization may implement different rules for different users. For example, reservations made by executives may be cancelled or modified when reserved rooms or devices are unused for 30 minutes or longer, but reservations made by part-time independent contractors or others who are frequently not in the office may be cancelled or modified when reserved rooms or devices are unused for 10 minutes or longer. An organization may establish these rules by programming the software 34 or other programs that interact with the software 34.

The computer system 12 also warns users of reservation violations. For example, anytime a reservation is cancelled or cut-short, the computer system 12 may send the user a warning via email or text to inform the user the meeting room or device was not used pursuant to the reservation and therefore the reservation was cancelled. Such warnings may also be sent to managers, scheduling administrators, or others and may include notices of changes to the user's future reservation rights as discussed below.

The computer system 12 may also modify future reservation rights of users pursuant to customizable rule settings. For example, the computer system 12 may suspend or otherwise limit a user's ability to make additional reservation requests when the user fails to use a room or device pursuant to previous reservations. As with the above-described rules for cancelling current reservations, the rules for cancelling or suspending future reservation rights are customizable so that each organization may determine when and how reservation rights should be restricted. An organization may establish these rules by programming the software 34 or other programs that interact with the software 34.

For example, an organization with ample conference room space may implement a relatively lenient rights policy that only prevents or restricts future reservations of meeting rooms or devices when users fail to use reserved rooms or devices 5 times in a row, whereas an organization with limited conference room space may implement a relatively strict rights policy that that prevents future reservations when users fail to use rooms or devices a single time. An organization may also implement different reservation rights policies for different rooms or devices. For example, reservations for heavily-used and highly-desired conference rooms may be made only by users with no reservation infractions in the last year, whereas reservations for infrequently-used projectors or other devices may be made by any users with no reservation infractions in the last 10 days. Similarly, an organization may implement different reservation rights policies for different users. For example, future reservation rights of executives may be cancelled or suspended for a week when they fail to use reserved rooms or devices five times in a month, whereas future reservation rights of a part-time independent contractors may be cancelled or suspended for a month when they fail to use a reserved room or device once in a month.

In other embodiments, the scheduling and management system 10 may also be used to trigger payments for rooms or devices that are available to rent, such as meeting rooms, exercise equipment, or other devices provided by hotels and similar organizations. Authorized users who wish to have access to a room or device for rent first enter or otherwise provide payment information to the computer system 12, or such payment information may be provided or automatically detected at the time of use of the room or device. One of the sensors 18, 20 monitors occupancy of the room or use of the device and transmits occupancy or use information to the computer system 12. The computer system 12 evaluates the occupancy or use information transmitted by the sensor and initiates a payment transaction via the payment interchange 24 if the occupancy or use information indicates a room or device is being used.

### Exemplary Computer-Implemented Method

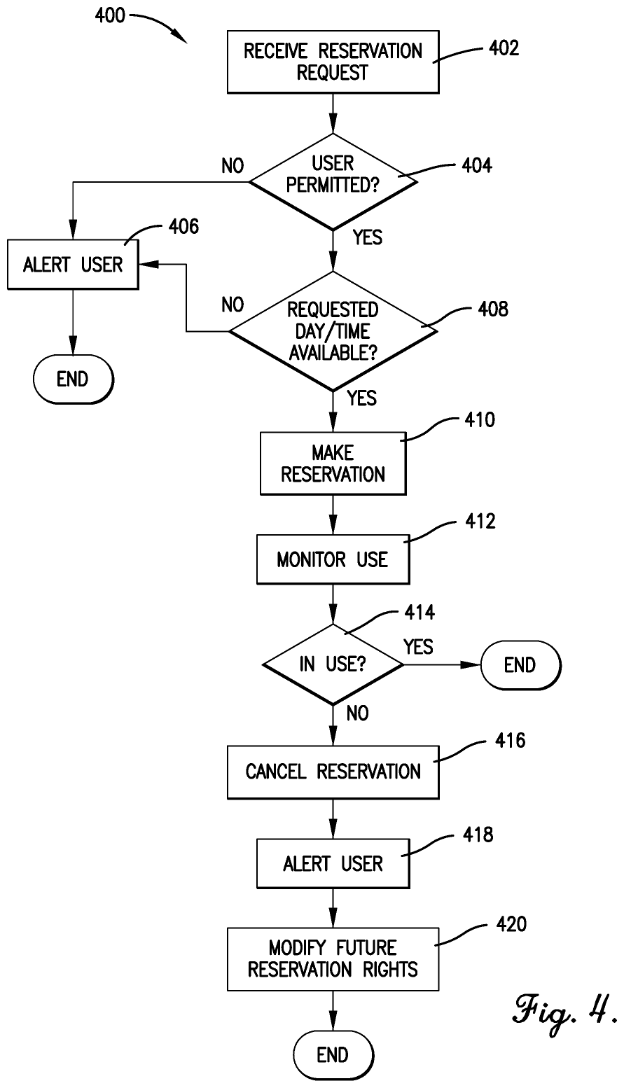

FIG. 4 depicts steps of an exemplary computer-implemented method 400 for scheduling and managing reservations of conference rooms and other rooms and devices. Some steps may be performed concurrently as opposed to sequentially and may in some cases be performed in a different order. In addition, some steps may be optional, and other steps may be added.

The computer-implemented method 400 is described below, for ease of reference, as being executed by exemplary devices and components introduced with the embodiments illustrated in FIGS. 1-3. For example, the steps of the computer-implemented method 400 may be performed by the computer system 12, the reservation software 34 and other programs hosted on the computer system 12, the electronic devices 14, 16, the sensors 18, 20 and/or the payment interchange 24. However, responsibility for all or some of such actions may be distributed differently among such devices or other computing devices without departing from the spirit of the present invention. Moreover, the method 400 is described in connection with a meeting room, but it may be used with any space, device, or item.

In particular embodiments, at least some of the steps of the method 400 are performed by one or more computer-readable medium(s). The computer-readable medium(s) may store the reservation software 34 thereon, and the reservation software 34 may instruct one or more of the devices of the system 10 to perform all or certain of the steps outlined herein. The reservation software 34 and/or other program(s) stored on the computer-readable medium(s) may instruct the system 10 to perform additional, fewer, or alternative actions, including those discussed elsewhere herein.

For the sake of brevity and clarity, descriptions of well-known electronic transaction technology and data, including those described above, will be generally avoided here. As a particular example, the structure, function and/or use of technology and data commonly associated with electronic credit card transactions should be understood to apply to the embodiments of the present invention outlined hereinbelow except as otherwise described in or fairly understood from this disclosure. However, certain otherwise generally known technology or data—such as hardware, software or processes—may be described herein, for instance in cases where the structure, function and/or use are considered related to and/or are altered under novel aspects of embodiments of the present invention.

Turning now to FIG. 4, the method 400 begins when a user accesses the computer system 12 with an electronic device 14, 16 or any other device and requests to reserve a conference room or device on a particular day and for a time period as depicted in step 402. For simplicity, the remainder of the method 400 will be described as involving a conference room, but the method also applies to other rooms and devices. The request identifies the user, the conference room and the day and time for the reservation. In some embodiments that require a user to pay for use of a room as explained below, the user is prompted to enter credit card information or other payment information along with the reservation request. In some embodiments, the electronic device 14, 16 connects to the computer system 12 with a web browser that establishes connections via the communications link 22. In other embodiments, the electronic device 14 or 16 includes resident applications that interact with the reservation software 34 on the computer system 12.

The computer system 12 then determines whether the user is currently permitted to reserve the requested room as depicted in step 404. Examples of why the user may not be permitted to do so are explained above and below. If the user is not permitted to make a reservation, the computer system 12 alerts the user in step 406.

The computer system 10 then determines if the room is available at the requested time in step 408, and if its not, alerts the user in step 406.

If the user is permitted to make a reservation and the requested time is available, the computer system 12 creates a reservation as depicted to step 410.

During the time period of the scheduled reservation, one or more of the sensors 18, 20 monitor occupancy of the room and transmit occupancy information to the computer system 12 as depicted in step 412.

The computer system evaluates the occupancy information in step 414 and cancels the reservation if the occupancy information indicates the room is not being used pursuant to the reservation as depicted in step 416. For example, if a user reserves a room starting at 2 PM and the sensor detects no occupancy in the room for 10 minutes after 2 PM, the computer system cancels the reservation, so others may use the room. In another example, if a user reserves a room starting at 2 PM for 2 hours and the sensor initially detects occupancy in the room after 2 PM but detects no occupancy after 3 PM, the computer system cancels the remainder of the reservation, so others may use the room. The computer system may also cancel future reservations in a recurring reservation if a user fails to use the reserved room 2 weeks in a row.

The computer system 12 then warns the user of the reservation violation as set forth in step 418. For example, the computer system may send the user a warning via email or text to inform the user the meeting room was not used pursuant to the reservation and therefore the reservation was cancelled. Such warnings may also be sent to managers, scheduling administrators, or others.

The computer system 12 then modifies future reservation rights of the user as set forth in step 420. For example, the computer system may suspend or otherwise limit the user's ability to make additional reservation requests for two weeks.

The method may include additional, less, or alternate actions, including those discussed elsewhere herein.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for managing reservations of rooms, the method comprising:
receiving in a computer system a reservation request from a user to reserve a room for a time period;
creating a reservation with the computer system to reserve the room for the user for the time period;
monitoring occupancy of the room during the time period with a sensor to determine if the user is using the room pursuant to the reservation;
cancelling the reservation if the monitoring step determines the user is not using the room pursuant to the reservation; and
modifying future reservation rights of the user pursuant to customizable rule settings.

2. The computer-implemented method as set forth in claim 1, wherein the monitoring step comprises monitoring motion in the room during the time period with motion detectors to determine if the user is using the room pursuant to the reservation.

3. The computer-implemented method as set forth in claim 2, wherein the cancelling step comprises cancelling the reservation if the monitoring step detects no motion in the room for a pre-determined amount of time during the time period.

4. The computer-implemented method as set forth in claim 1, wherein the monitoring step comprises monitoring occupancy of the room during the time period with infrared cameras to determine if the user is using the room pursuant to the reservation.

5. The computer-implemented method as set forth in claim 1, wherein the monitoring step comprises monitoring occupancy of the room during the time period with a door switch to determine if the user is using the room pursuant to the reservation.

6. The computer-implemented method as set forth in claim 1, wherein the monitoring step comprises monitoring occupancy of the room during the time period with a light sensor to determine if the user is using the room pursuant to the reservation.

7. The computer-implemented method as set forth in claim 1, further comprising the step of warning the user that the room was not used pursuant to the reservation.

8. The computer-implemented method as set forth in claim 1, wherein the modifying step comprises suspending the user's ability to make additional reservation requests during a suspension period.

9. The computer-implemented method as set forth in claim 1, further comprising the step of triggering a payment authorization when the monitoring step determines the user is using the room pursuant to the reservation.

10. The computer-implemented method as set forth in claim 1, wherein the room is selected from the group consisting of a meeting room, a conference room, a park shelter, a sport court, an exercise room, a club house, and an office.

11. A computer-implemented method for managing reservations of rooms, the method comprising:
receiving in a computer system a reservation request from a user to reserve a room for a time period;
determining with the computer system whether the room is available during the time period;
creating a reservation with the computer system to reserve the room for the user for the time period if the room is available during the time period;
monitoring occupancy of the room during the time period with a sensor to determine if the user is using the room pursuant to the reservation;
cancelling the reservation if the monitoring step determines the user is not using the room pursuant to the reservation; and
modifying reservation rights of the user pursuant to customizable rule settings, the modifying step including—
warning the user that the room was not used pursuant to the reservation, and
suspending the user's ability to make additional reservation requests during a suspension period.

12. The computer-implemented method as set forth in claim 11, wherein the monitoring step is a step selected from the group consisting of: monitoring motion in the room with a motion detector, monitoring occupancy of the room with an infrared camera, monitoring occupancy of the room with a door switch, and monitoring occupancy of the room with a light sensor.

13. The computer-implemented method as set forth in claim 11, further comprising the step of triggering a payment authorization when the monitoring step determines the user is using the room pursuant to the reservation.

14. A system for managing reservations of rooms, the system comprising:
a computer system programmed to—
receive a reservation request from a user to reserve a room for a time period;
determine whether the room is available during the time period; and
create a reservation to reserve the room for the time period if the room is available during the time period;
a sensor in communication with the computer system and configured to monitor occupancy of the room during the time period and transmit occupancy information to the computer system regarding the occupancy;
the computer system further programmed to—
cancel the reservation if the occupancy information indicates the user is not using the room pursuant to the reservation; and
modify future reservation rights of the user pursuant to customizable rule settings.

15. The system as set forth in claim 17, wherein the computer system is further programmed to warn the user that the room was not used pursuant to the reservation and suspend the user's ability to make future reservation requests during a suspension period.

16. The system as set forth in claim 17, wherein the sensor is selected from the group consisting of: a motion detector, an infrared camera, a door switch, and a light sensor.

17. The system as set forth in claim 17, wherein the computer system is further programmed to trigger a payment authorization if the user is using the room pursuant to the reservation.

18. The system method as set forth in claim 14, wherein the computer system cancels the reservation if the sensor detects no motion in the room for a pre-determined amount of time during the time period.

19. The system method as set forth in claim 14, wherein the computer system modifies the future reservation rights of the user by suspending the user's ability to make additional reservation requests during a suspension period.

20. The system method as set forth in claim 14, wherein the room is selected from the group consisting of a meeting room, a conference room, a park shelter, a sport court, an exercise room, a club house, and an office.
